(19) United States
(12) Patent Application Publication
(10) Pub. No.: US 2024/0416401 A1
(43) Pub. Date: Dec. 19, 2024

(54) REMOVAL OF PFAS FROM CONTAMINATED SOIL

(71) Applicant: Harbour Stone B.V., Willemstad (NL)

(72) Inventors: Arjen Varekamp, Maassluis (NL); Korstiaan Petrus Willem Kamp, Oude-Tonge (NL); Wilhelmus Hendrikus Van der Zon, Rijswijk (NL)

(21) Appl. No.: 18/704,838

(22) PCT Filed: Oct. 27, 2022
(86) PCT No.: PCT/EP2022/080121

§ 371 Date: Apr. 25, 2024

(30) Foreign Application Priority Data
Oct. 28, 2021 (NL) 2029538

(51) Int. Cl. B09C 1/06; B01D 53/02; B01D 53/14; B01D 53/76; C02F 11/06

(52) U.S. Cl. CPC B09C 1/06; B01D 53/76; C02F 11/06; B01D 53/02; B01D 53/14; B01D 2253/102; B01D 2253/108; B01D 2257/206; B01D 2258/0291

(57) ABSTRACT

The invention comprises a process for remediation of soil comprising PFAS. The process comprises steps a)-d). In step a) sludge and a first gaseous stream are heated in a first spouting bed incinerator, thereby generating a raw material for a ceramic article and a first gaseous stream comprising a first flue gas, the first gaseous stream comprising the first flue gas having a temperature of at least 800° C. In step b) the first gaseous stream comprising the first flue gas is heat exchanged with a second gaseous stream in an air-to-air heat exchanger, thereby generating a second gaseous stream with a temperature of at least 500° C. In step c) the soil comprising PFAS is contacted with the second gaseous stream in a dryer, thereby evaporating the PFAS from the soil and generating clean soil and a second gaseous stream comprising PFAS. In step d) the second gaseous stream comprising PFAS is further heated to a temperature of at least 1000° C. in a second spouting bed incinerator, thereby generating a second gaseous stream comprising destructed PFAS.

The present invention relates to a process for remediation of soil comprising PFAS, and to the use of a spouting bed incinerator in such a process.

### BACKGROUND ART

Since the 1960's, many new chemicals have been developed and used in a variety of industrial and household products. An example is the substance group of per- and polyfluoroalkyl substances (PFAS). These substances were used because of their unique properties. They are both water and oil repellent and are resistant to e.g. heat and acids. Many different variations of PFAS exist, and the substance group currently comprises more than 6000 compounds.

The application of these compounds in industrial or household products is very diverse. They have been used as stain protectors in carpets, for water-repellent textile, for metalworking processes, for the production of non-stick materials and as auxiliary substances in certain types of fire extinguishing foams. However, since about the year 2000, substances from the PFAS group have received increasing attention because scientific research has shown that these substances are persistent, bioaccumulative, and toxic (PBT). In addition, measurements have shown that these substances are present in our environment on a large scale.

Basically PFAS consist of a chain of carbon (C) and fluorine (F) atoms, with a specific substance group added. The best known substances are PFOS (perfluorooctane sulfonic acid) and PFOA (perfluorooctanoic acid). Until recently, PFOS was used in, for example, fire extinguishing foams. PFOS provides an aqueous film between liquids and fire extinguishing foam and is resistant to very high temperatures. As a result, this type of fire-fighting foam was prescribed at airports, fuel depots, drilling platforms and other installations with large quantities of liquid fuels. PFOA was an adjuvant in the production of Teflon and has been used in many other products because it contributes to a good oil and water-repellent effect.

The use of PFOS and PFOA is—as far as possible—prohibited by law in the Netherlands. Despite the phasing out, these substances are still present in the environment. Moreover, these substances have been replaced by other PFAS that are still being used and, although sometimes in a lesser extent, are still PBT.

The techniques with which PFAS contaminants can be destructed are limited. Many technologies that can be used for regular contaminants cannot be used for PFAS due to their low volatility and poor degradability. Feasibility tests with the most common ex-situ cleaning methods have shown that for clearing excavated soil, extractive cleaning (soil washing) is currently the only feasible method. Soil washing is an ex-situ remediation technique that removes hazardous contaminants from soil by washing the soil with a liquid (often with a chemical additive), scrubbing the soil, and then separating the clean soils from contaminated soil and washwater. PFAS can subsequently be removed from the liquid phase by adsorption on for example, activated carbon. However, a point of attention remains the following processing of the contaminated carbon. Very high temperatures (from 1000 to 1200° C.) are needed to completely break down PFAS, which makes destruction of additional waste streams from PFAS treatment very energy intensive and therefore expensive.

The high break down temperature of PFAS is also the reason why for example conventional thermal soil cleaning (evaporation of contaminating compounds at 500 to 600° C., followed by post-combustion at approximately 750° C.) has not proved effective for soil contaminated with PFOS and PFOA (Een handelingskader voor PFAS—Expertisecentrum PFAS—25-6-2018—ISBN/EAN: 978-90-815703-0-5).

Only a limited number of patent publications related to removal of PFAS from contaminated soil presently exist. US2018319685, US2019300387, and WO19113268A1 for example disclose methods in which PFAS contaminated soil is cleaned by washing the soil. Also the cyclodextrins of US2018282530 are to be used in liquid media. US2019314876 is different in that it discloses heating the soil at a temperature in the range of 225 to 440° C. to first evaporate PFAS. Steam is added to the evaporated PFAS, and a concentrated aqueous PFAS solution is produced. Thus, although US2019314876 does not disclose washing of the soil, the PFAS is obtained in an aqueous phase. Therefore, the abovementioned methods all suffer from the disadvantage that additional waste streams are generated, the destruction of which requires a large energy input.

US2021106860 discloses the decontamination of contaminated solid materials such as soil, for example polluted by PFAS, by heating the materials under vacuum at a temperature able to volatilize the contaminant. WO2021102519 discloses decontamination of soil polluted with PFAS by pyrolysis. US2018345338A as well as Duchesne et al. (Environ. Sci. Technol. 2020, 54, 12631) also disclose an all thermal destruction method. Smoldering combustion is used to decontaminate soils containing PFAS. Soil is treated with a solid fuel comprising organic material. The mixture is heated to 200° C. to 400° C. to initiate smoldering combustion and an oxidizer gas is forced through the heated mixture such that the smoldering combustion is self-sustaining until the mixture reaches a PFAS destructive temperature and the perfluoroalkylated substances are thermally destroyed. The resulting flue gas will require a treatment due to the release of hydrogen fluoride and other fluorous gases. US2018345338A mentions that no mechanism exists to utilize energy generated from the treatment of other wastes, e.g. hydrocarbon impacted soils, coal tar or other fuels, to ease the energy and cost burden. This is in line with what was reported in Een handelingskader voor PFAS—Expertisecentrum PFAS—25-6-2018—ISBN/EAN: 978-90-815703-0-5, i.e. that washing methods appear to be the only feasible method.

Due to the high associated costs, facilities that will accept PFAS contaminated waste are limited. However, due to the abundance of PFAS in the environment and stringent demands related to the accepted level of PFAS contamination in soils, novel and more cost effective methods of PFAS remediation are a necessity. It is an objective of the present invention to provide an improved method and system for remediation of soil containing PFAS or at least to provide a useful alternative.

### SUMMARY OF THE INVENTION

Thereto, the present invention provides a process for remediation of soil comprising PFAS, the process comprising:
a) heating sludge and a first gaseous stream in a first spouting bed incinerator, thereby incinerating organic materials in the sludge and generating a raw material for a ceramic article and a first gaseous stream comprising a first flue gas, the first gaseous stream comprising the first flue gas having a temperature of at least 800° C.,
b) heat-exchanging the first gaseous stream comprising the first flue gas with a second gaseous stream in an air-to-air heat exchanger, thereby generating a second gaseous stream with a temperature of at least 500° C.,
c) contacting the soil comprising PFAS with the second gaseous stream with a temperature of at least 500° C. in a dryer, thereby evaporating the PFAS from the soil and generating clean soil and a second gaseous stream comprising PFAS,
d) destructing PFAS contained in the second gaseous stream at a temperature of at least 1000° C. in a second spouting bed incinerator, thereby generating a second gaseous stream comprising destructed PFAS.

Surprisingly, contrary to the popular opinion that energy generated from the treatment of other waste cannot be used beneficially in remediation of PFAS contaminated soils, it has now been found that a gaseous stream comprising flue gas, generated in a process for preparing a raw material for a ceramic article from sludge, can be used advantageously in a process for remediation of soil containing PFAS. Due to the unique combination of features, i.e. heating of the PFAS in two stages-first in the dryer in step c) and subsequently to a higher temperature in the spouting bed incinerator in step d)—the use of gaseous streams for heating, and the use of a spouting bed incinerator, the temperature in step d) can be increased to such a value that PFAS from contaminated soil can be destructed without requiring an aqueous phase in the process of removing PFAS from the soil, thus reducing the amount of waste streams and the required cleaning steps for these waste streams as compared to traditional PFAS remediation techniques.

### DETAILED DESCRIPTION OF THE INVENTION

From WO 2019160409 A1, a process for preparing a raw material for a ceramic article from sludge is known. This application discloses a process for the preparation of a ceramic article containing industrial, domestic or natural sludge. The sludge has been pre-treated by a process comprising the optional step of drying the sludge to a moisture continent of at most 10% by weight, resulting in dried sludge, and heating the sludge or dried sludge in a spouting bed incinerator and reducing the content of organic matter to less than 5% by weight, resulting in a raw material for a ceramic article.

In the present invention, energy generated from a similar pre-treatment process of sludge is used advantageously in a process for remediation of soil containing PFAS.

In step a) of the process according to the invention, sludge and a first gaseous stream are heated in a first spouting bed incinerator. The first gaseous stream as well as the second gaseous stream preferably comprise oxygen, more preferably at least 5% oxygen, even more preferably at least 10% oxygen, such as at least 15% or 20% oxygen. Preferably the first and/or second gaseous streams are airstreams. Preferably, the first and second gaseous streams are at ambient temperature (e.g. from 0-30° C.) before entering the process in steps a) and b) respectively, although they may be pre-heated, for example to temperatures of at least 50, 70 or 90° C.

Sludge is a common waste material to be incorporated in building materials. Sludge can arise from many different origins. Domestic sludge (which includes agricultural sludge) is mainly organic and biodegradable, in contrast to industrial sludge, which is often in inorganic form (e.g. marble sludge, stone sludge, ceramic sludge). Organic components of industrial sludge typically are not biodegradable. Another form of sludge is natural sludge, which may—similar to domestic sludge—contain organic and biodegradable components. Domestic sludge is associated with human residential waste, and includes for example sewage sludge, sludge from waste water treatment plants or other forms of treatment of human residential waste. Domestic and natural sludge typically comprise a high quantity of water and biodegradable organic matter. Typically, the water content lies between 60 and 90%. The dry content of organic matter typically lies between 40-80% by weight of the dry matter. Industrial sludge may comprise organic matter that is combustible. The industrial sludge that is used in the present invention may have a dry content of combustible organic matter in the range of 40-80% by weight of the dry matter. Preferably, the sludge is dried to a moisture continent of at most 10% by weight, resulting in dried sludge, which dried sludge is then heated in the first spouting bed incinerator. Preferably, the sludge is sludge resulting from a wastewater treatment process.

A spouting bed incinerator is a form of Dynamic Thermal Oxidation (DTO). Incineration in a spouting bed incinerator is a dynamic process. The air speed and the temperature inside the combustion chamber of the incinerator ensure the “cutting” of the feedstock. The shape of the combustion chamber provides the thermal driven circulation, whereby the feedstock particles undergo thermal treatment over their entire surface area. The combination of the air velocity, temperature, specific gravity and specific weight of the particles regulate the residence time and the point of “unloading” of the processed particles. Typically the feedstock, by itself or with added fuel, has a caloric value of at least 4 MJ.

Preferably, the sludge has a caloric value of at least 4 MJ. Therefore, preferably, no extra fuel is supplied to the first spouting bed incinerator. If extra fuel is needed in order to keep the combustion process going, preferably the fuel is solid recovered fuel (SRF) or refuse derived fuel (RDF). RDF is produced from domestic and business waste, which includes biodegradable material as well as plastics. Non-combustible materials such as glass and metals are removed, and the residual material is then shredded. SRF is a high-quality alternative to fossil fuel produced from mainly commercial waste including paper, card, wood, textiles and plastic. Solid recovered fuel has gone through additional processing to improve the quality and value. It has a higher calorific value than RDF. Additionally or alternatively, the fuel may be a conventional fuel, such as a conventional solid, liquid or gaseous fuel. Examples of solid fuels are wood, coal, peat, dung, coke, charcoal, etc. Examples of liquid fuels are petroleum, diesel, gasoline, kerosene, LPG, coal tar, naphta, ethanol, etc. Examples of gaseous fuels are natural gas, hydrogen, propane, methane, coal gas, water gas, blast furnace gas, coke oven gas, CNG, etc.

Spouting bed incinerators are known. For instance, in RU2249763C1 fire-chambers with spouting beds are described that may be used in heat power engineering. The fire-chamber with a spouting beds of this reference contains a cylindrical combustion-chamber made with the height of its cylindrical part making 10-15% of the height of the conical part, and at an angle of inclination of the conical part wall in respect to the vertical equal to 10-20°, and the height of the conical part making 3-5 its average internal diameters. Under the combustion chamber there is an ignition chamber with the tangential connecting pipes to supply air and flue gases and the injector for a preliminary ignition of a comminuted fuel. As the speeds of a gas stream along the height of the combustion chamber are various, then particles of the fuel depending on their sizes are located in the conical part according to values of the speeds of their liquefaction and airborne. The particles of fuel burning down are flying to a stabilizer-deflector made in the form of a radial shutters. At that a part of them is deflected and refunded into the conical part. The particles having passed through the stabilizer-deflector together with the flue gases are driven into a high-temperature cyclone separator located outside the fire-chamber. A spouting bed incinerator is also known from U.S. Pat. No. 4,047,883A and art described therein. Moreover, spouting bed incinerators are used for incineration of (hazardous) waste, e.g., by the EMGroup in Geleen, The Netherlands, (http://www.emgroup.nl/en/products/incinerators/).

Typically, the temperature in a spouting bed incinerator is in the range of 900 to 1250° C. Typically, the residence time in the spouting bed incinerator is in the range of 1 to 10 seconds. Gas velocity is at least 10 m/s. The capture of the final processed material typically takes place by means of cyclones which are driven by the combustion air. The cyclones transport the processed material via airflow and gravity e.g., to a storage or a further transport operation. The use of a spouting bed incinerator results in the full incineration of organic materials, without the side effect of sintering of the inorganic materials. The product of step a), i.e. pre-treated sludge or a raw material for a ceramic article, captured by use of a cyclone or similar gas/solid separator, can be applied in bricks without fear of inferior properties.

The raw material for a ceramic article generated in step a) represents a first stream of material generated by the first spouting bed incinerator. A second stream of material is hot gas, i.e. the first gaseous stream comprising the first flue gas, which flue gas is generated due to the combustion and subsequent gasification of organic matter. Due to the high temperature in the spouting bed incinerator, the first gaseous stream comprising the first flue gas has a temperature of at least 800° C., such as at least 850° C., preferably at least 900° C. For example, the temperature of the first gaseous stream comprising the first flue gas is between 800-1400° C., preferably between 850-1350° C., more preferably between 900-1100° C. When fed to an air-to-air heat exchanger for heating a second gaseous stream, the second gaseous stream can be heated to temperatures of at least 500° C. This is step b) of the process of the present invention, which thus results in a second gaseous stream with a temperature of at least 500° C., preferably at least 550° C., more preferably at least 600° C., such as between 500-900° C., preferably between 550-850° C., more preferably between 600-800° C.

In the heat exchanger, the first gaseous stream comprising the first flue gas is cooled to a cooled first gaseous stream comprising the first flue gas. The cooled first gaseous stream comprising the first flue gas may be cleaned in a first cleaner. The first cleaner may for example comprise a scrubber, active carbon, zeolite or a combination of one or more of these.

In step c), the soil comprising PFAS is contacted with the second gaseous stream in a dryer. The dryer may be for example be a rotating drum or a sieve. Due to the contact with the second gaseous stream, PFAS and other contaminating compounds are effectively and efficiently evaporated, and subsequently carried to the second spouting bed incinerator by the second gaseous stream. The use of a gaseous stream for heating has an advantage over other heating methods, such as direct combustion or indirect heating through a dryer wall. Such heating methods usually lead to locally high temperatures, which may in turn lead to the sintering of parts of the soil. In the process of the present invention, sintering is avoided due to the use of a gaseous stream. Thus, the generated clean soil is not sintered, which would adversely affect the granulometry of the soil. The evaporated PFAS and other contaminating compounds are subsequently transferred to a second spouting bed incinerator by the second gaseous stream.

In step d) the second gaseous stream is further heated to a temperature of at least 1000° C., such as at least 1100° C., preferably at least 1150° C. in a second spouting bed incinerator, thereby generating a second gaseous stream comprising destructed PFAS. The destructed PFAS comprises hydrogen fluoride, among other low molecular weight compounds. The second gaseous stream comprising destructed PFAS leaves the second spouting bed incinerator through a cyclone or similar gas/solid separator and may be cleaned in a second cleaner. The second cleaner may for example comprise a scrubber, active carbon, zeolite or a combination of one or more of these. A small solid stream may also leave the cyclone or similar gas/solid separator. Preferably, this solid stream is recycled to step c), i.e. the solid stream may be combined with the soil comprising PFAS before or during the contact with the second gaseous stream.

Preferably, extra fuel is supplied to the second spouting bed incinerator, which fuel preferably is SRF or RDF. Additionally or alternatively, the fuel may be a conventional fuel, such as a conventional solid, liquid or gaseous fuel. Preferably the extra fuel supplied to the second spouting bed incinerator is SRF, RDF or natural gas, most preferably natural gas.

The process of the present invention results in clean soil, which comprises less than 3.0 μg/kg, such as less than 1.4 μg/kg, or even less than 0.1 μg/kg of each individual PFAS compound. Thus, the clean soil may comprise e.g. 2.5 μg/kg pf PFOS, 2.5 μg/kg of PFOA and 2.5 μg/kg of one or more other individual PFAS compounds.

The invention further relates to the use of a spouting bed incinerator in a process for remediation of soil comprising PFAS. In embodiments, the spouting bed incinerator is used for increasing the temperature of a gaseous stream comprising PFAS to a temperature suitable for destruction of PFAS (i.e. at least 1000° C.), the gaseous stream having an initial temperature of at least 500° C., preferably between 500-900° C.

### BRIEF DESCRIPTION OF THE DRAWING

FIG. 1 is a flow chart of a process according to the invention.

### DETAILED DESCRIPTION OF THE DRAWING

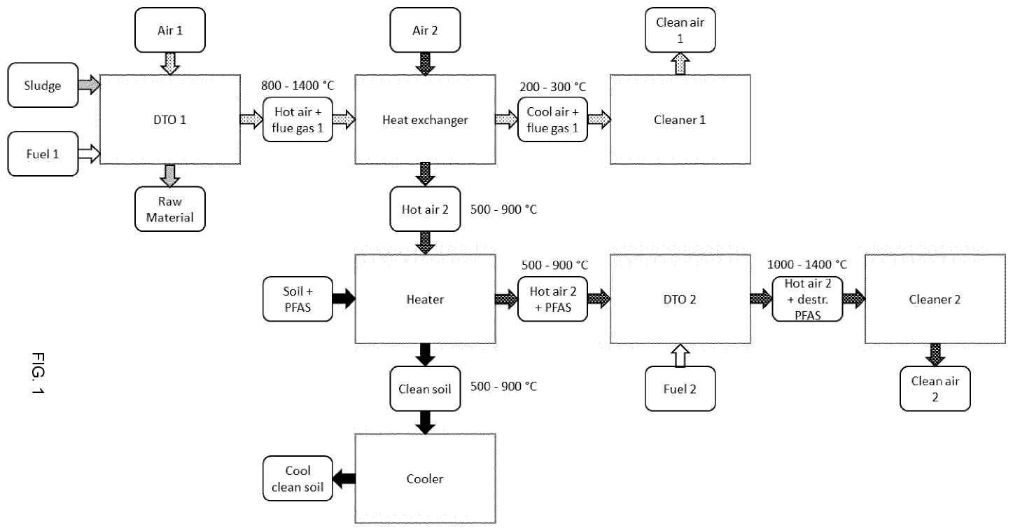

The flowchart of FIG. 1 depicts an embodiment of a process according to the invention. Sludge and an optional fuel are fed to the first spouting bed incinerator (DTO 1). The sludge preferably has been dried to a moisture content of at most 10%. In the first spouting bed incinerator, the organic material in the sludge and the optional fuel are combusted at a temperature of between 80° and 1400° C., for example with a residence time of 1 to 10 seconds and at a gas velocity of at least 10 m/s, with a first gaseous stream, such as an airstream (Air 1), typically having ambient temperature. This results in treated sludge, which is suitable for use as a raw material for producing a ceramic article such as a brick (Raw Material). The first gaseous stream comprising the first flue gas (Hot air+flue gas 1) has a temperature of at least 800° C., such as between 80° and 1400° C.

In the air to air heat exchanger (Heat exchanger), heat is exchanged between the first gaseous stream comprising the first flue gas and the second gaseous stream (Air 2), which gaseous stream typically is of ambient temperature. This results in a cooled gaseous stream comprising the first flue gas (Cool air+flue gas 1), and a second gaseous stream (Hot air 2). The cooled gaseous stream comprising the first flue gas has a temperature of about 200-300° C., and may be cleaned in a first cleaner (Cleaner 1), such as a scrubber, resulting in a first clean gaseous stream (Clean air 1).

The second gaseous stream has a temperature of at least 500° C., for example between 50° and 900° C. The second gaseous stream is used in the dryer (Heater) to heat the soil comprising PFAS (Soil+PFAS) in order to evaporate PFAS from the soil. Clean soil (Clean soil) leaves the dryer at a high temperature of about at least 500° C., and is cooled in a cooler (Cooler), typically to temperatures below 50° C. to produce cool clean soil (Cool clean soil) which comprises less than 3.0 μg/kg, such as less than 1.4 μg/kg, typically less than 0.1 μg/kg of PFAS per individual compound, which cool clean soil may subsequently be transported, and is ready for use in applications such as road construction. Optionally, heat from the cooler may be used to pre-heat the first gaseous stream and/or second gaseous stream.

PFAS leaves the dryer in a second gaseous stream comprising PFAS (Hot air 2+PFAS). Said gaseous stream typically has a temperature of at least 500° C., for example between 50° and 900° C. The gaseous stream comprising PFAS is then further heated in the second spouting bed incinerator (DTO 2), where a temperature of at least 1000° C. is reached due to combustion of the PFAS and other impurities also comprised in the gaseous stream, and optional addition of a second fuel (Fuel 2). Leaving the second spouting bed incinerator is the second gaseous stream comprising destructed PFAS (Hot air 2+destr. PFAS). The second gaseous stream is cleaned in a second cleaner (Cleaner 2), such as a scrubber, resulting in a second clean gaseous stream (Clean air 2).

In the FIGURE, the gray arrows illustrate the route of the sludge through the process. The grey dotted arrows indicate the route of the first gaseous stream. The dark dotted arrows indicated the route of the second gaseous stream, and the black arrows indicate the route of the soil.

### CLAUSES

In the invention, the term “first gaseous stream” may be read interchangeably as “first gas stream”. The term “first gaseous stream comprising a (/the) first flue gas” may be read interchangeably as “second gas stream comprising a (/the) first flue gas”. The term “second gaseous stream” may be read interchangeably as “third gaseous stream”. The term “second gaseous stream with a temperature of at least 500° C.” may be read interchangeably as “fourth gas stream with a temperature of at least 500° C.”. The term “second gaseous stream comprising PFAS” may be read interchangeably as “fifth gas stream comprising PFAS”. The term “second gaseous stream comprising destructed PFAS” may be read interchangeably as “sixth gas stream comprising destructed PFAS”. Thus, the invention equally relates to the following clauses.
Clause 1. Process for remediation of soil comprising PFAS, the process comprising:
   a) heating sludge and a first gas stream in a first spouting bed incinerator, thereby incinerating organic materials in the sludge and generating a raw material for a ceramic article and a second gas stream comprising a first flue gas, the second gas stream comprising the first flue gas having a temperature of at least 800° C.,
   b) heat-exchanging the second gas stream comprising the first flue gas with a third gas stream in an air-to-air heat exchanger, thereby generating a fourth gas stream with a temperature of at least 500° C.,
   c) contacting the soil comprising PFAS with the fourth gas stream with a temperature of at least 500° C. in a dryer, thereby evaporating the PFAS from the soil and generating clean soil and a fifth gas stream comprising PFAS,
   d) destructing PFAS contained in the fifth gas stream at a temperature of at least 1000° C. in a second spouting bed incinerator, thereby generating a sixth gas stream comprising destructed PFAS.
Clause 2. Process according to clause 1, wherein the temperature of the second gas stream comprising the first flue gas is between 800-1400° C., preferably between 850-1350° C., more preferably between 900-1100° C.
Clause 3. Process according to clause 1 or 2, wherein the temperature of the fourth gas stream with a temperature of at least 500° C. is between 500-900° C., preferably between 550-850° C., more preferably between 600-800° C.
Clause 4. Process according to any one of the preceding clauses, wherein after step b), the second gas stream comprising the first flue gas is cooled to a cooled second gas stream comprising the first flue gas, and the cooled second gas stream comprising the first flue gas is cleaned in a first cleaner.
Clause 5. Process according to any one of the preceding clauses, wherein after step d) the sixth gas stream comprising destructed PFAS is cleaned in a second cleaner.
Clause 6. Process according to any one of the preceding clauses, wherein a solid stream leaves the second spouting bed incinerator, which solid stream is combined with the soil comprising PFAS in step c).
Clause 7. Process according to any one of the preceding clauses, wherein additional heat for heating in step a) is generated by combustion of a first fuel, preferably solid recovered fuel (SRF) or refuse derived fuel (RDF).
Clause 8. Process according to any one of the preceding clauses, wherein heat for destructing PFAS in step d) is generated by combustion of a second fuel, preferably solid recovered fuel (SRF), refuse derived fuel (RDF) or natural gas, most preferably natural gas.
Clause 9. Process according to any one of the preceding clauses, wherein the clean soil comprises less than 3.0 μg/kg, preferably less than 1.4 μg/kg, more preferably less than 0.1 μg/kg of each individual PFAS compound.
Clause 10. Use of a spouting bed incinerator in a process for remediation of soil comprising PFAS, wherein the use is for destruction of PFAS, wherein the spouting bed incinerator is used for increasing the temperature of a gas stream comprising PFAS to a temperature suitable for destruction of PFAS, the gas stream having an initial temperature of at least 500° C., preferably between 500-900° C.

1. A process for remediation of soil comprising PFAS, the process comprising:
a) heating sludge and a first gaseous stream in a first spouting bed incinerator, thereby incinerating organic materials in the sludge, resulting in a raw material for a ceramic article and the first gaseous stream comprising a first flue gas, the first gaseous stream comprising the first flue gas having a temperature of at least 800° C.;
b) heat-exchanging the first gaseous stream comprising the first flue gas with a second gaseous stream in an air-to-air heat exchanger, thereby resulting in the second gaseous stream with a temperature of at least 500° C.;
c) contacting soil comprising PFAS with the second gaseous stream with a temperature of at least 500° C. in a dryer, thereby evaporating the PFAS from the soil, resulting in clean soil and the second gaseous stream comprising PFAS; and
d) destructing PFAS contained in the second gaseous stream at a temperature of at least 1000° C. in a second spouting bed incinerator, thereby resulting in the second gaseous stream comprising destructed PFAS.

2. The process according to claim 1, wherein the temperature of the first gaseous stream comprising the first flue gas in step a) is between 800-1400° C.

3. The process according to claim 1, wherein the temperature of the resulting second gaseous stream with a temperature of at least 500° C. in step b) is between 500-900° C.

4. The process according to claim 1, wherein after step b), the first gaseous stream comprising the first flue gas is cooled to a cooled first gaseous stream comprising the first flue gas; and
wherein the method further comprising cooling the cooled first gaseous stream in a first cleaner.

5. The process according to claim 1 further comprising, after step d), cleaning the second gaseous stream comprising destructed PFAS in a second cleaner.

6. The process according to claim 1 further comprising:
separating the second gaseous stream comprising destructed PFAS in a gas/solid separator; and
combining a solid stream from the gas/solid separator with the soil comprising PFAS in step c).

7. The process according to claim 1 further comprising combusting a first fuel to generate additional heat for heating in step a).

8. The process according to claim 1 further comprising combusting a second fuel to generate heat for destructing PFAS in step d).

9. The process according to claim 1, wherein the clean soil comprises less than 3.0 μg/kg of each individual PFAS compound.

10. A spouting bed incinerator for remediation of soil comprising PFAS, wherein the spouting bed incinerator increases the temperature of a gaseous stream comprising PFAS to a temperature suitable for destruction of PFAS, thereby destructing the PFAS, and wherein the gaseous stream has an initial temperature of at least 500° C.

11. A process for remediation of soil comprising PFAS comprising:
heating sludge and a first gaseous stream in a first spouting bed incinerator, thereby incinerating organic materials in the sludge, resulting in a raw material and the first gaseous stream comprising a first flue gas, the first gaseous stream having a temperature between 800-1400° C.;
heat-exchanging the first gaseous stream with a second gaseous stream in an air-to-air heat exchanger, thereby resulting in the second gaseous stream having a temperature between 500-900° C.;
contacting soil comprising PFAS with the second gaseous stream in a dryer, thereby evaporating an amount of PFAS from the soil, resulting in an amount of clean soil and the second gaseous stream comprising PFAS; and
destructing PFAS contained in the second gaseous stream in a second spouting bed incinerator, thereby resulting in the second gaseous stream comprising destructed PFAS.

12. The process according to claim 11, wherein at least one of:
the temperature of the first gaseous stream comprising the first flue gas is between 850-1350° C.;
the temperature of the first gaseous stream comprising the first flue gas is between 900-1100° C.;
the temperature of the resulting second gaseous stream is between 550-850° C.;
the temperature of the resulting second gaseous stream is between 600-800° C.;
the clean soil comprises less than 3.0 μg/kg of each individual PFAS compound;
the clean soil comprises less than 1.4 μg/kg of each individual PFAS compound; or
the clean soil comprises less than 0.1 μg/kg of each individual PFAS compound.

13. The process according to claim 12 further comprising at least one of:
cooling a cooled first gaseous stream in a first cleaner, wherein after the heat-exchanging step, the first gaseous stream comprising the first flue gas is cooled to the cooled first gaseous stream comprising the first flue gas; or
cleaning the second gaseous stream comprising destructed PFAS in a second cleaner.

14. The process according to claim 13 further comprising:
separating the second gaseous stream comprising destructed PFAS in a gas/solid separator; and
combining a solid stream from the gas/solid separator with the soil comprising PFAS in the contacting step.

15. The process according to claim 11 further comprising at least one of:
combusting a first fuel to generate additional heat for the heating step; or
combusting a second fuel to generate heat for the destructing step.

16. The process according to claim 15, wherein the first fuel is selected from the group consisting of solid recovered fuel (SRF) and refuse derived fuel (RDF); and
wherein the second fuel is selected from the group consisting of SRF, RDF, and natural gas.

17. The process according to claim 11 further comprising:
combusting a first fuel to generate additional heat for the heating step;
cooling a cooled first gaseous stream in a first cleaner, wherein after the heat-exchanging step, the first gaseous stream comprising the first flue gas is cooled to the cooled first gaseous stream comprising the first flue gas;
combusting a second fuel to generate heat for the destructing step;
separating the second gaseous stream comprising destructed PFAS in a gas/solid separator;
combining a solid stream from the gas/solid separator with the soil comprising PFAS in the contacting step; and
cleaning the second gaseous stream comprising destructed PFAS in a second cleaner

18. The process according to claim 17, wherein at least one of:
the temperature of the first gaseous stream comprising the first flue gas is between 850-1350° C.;
the temperature of the first gaseous stream comprising the first flue gas is between 900-1100° C.;
the temperature of the resulting second gaseous stream is between 550-850° C.;
the temperature of the resulting second gaseous stream is between 600-800° C.;
the clean soil comprises less than 3.0 μg/kg of each individual PFAS compound;
the clean soil comprises less than 1.4 μg/kg of each individual PFAS compound;
the clean soil comprises less than 0.1 μg/kg of each individual PFAS compound;
the first fuel is selected from the group consisting of solid recovered fuel (SRF) and refuse derived fuel (RDF); or
the second fuel is selected from the group consisting of SRF, RDF, and natural gas.
